(19) United States
(12) Patent Application Publication
(10) Pub. No.: US 2010/0112348 A1
(43) Pub. Date: May 6, 2010

(54) Pressure Sensitive Adhesive for Optical Films and Pressure Sensitive Adhesive Optical Film

(75) Inventors: Makoto Kondo, Sayama-shi (JP); Mitsuhiko Nakazawa, Sayama-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: SOKEN CHEMICAL & ENGINEERING CO., LTD., Tokyo (JP)

(21) Appl. No.: 12/529,595

(22) PCT Filed: Mar. 4, 2008
(86) PCT No.: PCT/JP2008/053841

§ 371 Date: Sep. 2, 2009

(30) Foreign Application Priority Data
Mar. 7, 2007 (JP) 2007-057264

(51) Int. Cl. B32B 27/36; C09J 133/12

(52) U.S. Cl. 428/355 CN; 428/355 AC; 526/318.44

(57) ABSTRACT

Pressure sensitive adhesives for optical films include an acrylic copolymer (A) obtained by copolymerizing 95.0 to 98.0 parts by weight of n-butyl acrylate (a), 2.0 to 5.0 parts by weight of a hydroxyl group-containing (meth)acrylate (b) represented by Formula (1) below, and not more than 2.0 parts by weight of (meth)acrylic acid (c) (the total of (a) to (c) is 100 parts by weight), and satisfy specific requirements.

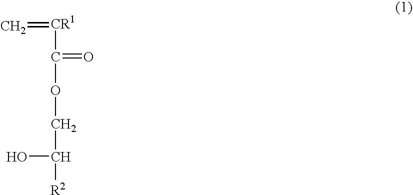

### FIELD OF THE INVENTION

The present invention relates to pressure sensitive adhesives for optical films and to pressure sensitive adhesive optical films. In more detail, the invention relates to pressure sensitive adhesives for optical films that contain a specific acrylic polymer, and pressure sensitive adhesive optical films having the pressure sensitive adhesive.

### BACKGROUND OF THE INVENTION

In thin display devices such as liquid crystal displays or plasma displays, specific functional films such as retardation films or polarizing plates are bonded with pressure sensitive adhesives. Recently, such thin display devices have been upsized and frequently used under severer conditions such as car navigation systems. As these thin display devices are used under severer conditions and their sizes are increased, it is more likely that the pressure sensitive adhesive layers bonding the functional films are separated or lifted.

To prevent the separation or lifting, the pressure sensitive adhesive layers should contain an acrylic copolymer having a specific 1000% modulus and excellent elongation properties. Naturally, properties such as break strength under tensile stress should be high. However, it is most often the case that the pressure sensitive adhesives do not actually have a good balance in all of these properties. For example, pressure sensitive adhesives having good moist heat resistance show poor heat resistance, or pressure sensitive adhesives with high heat resistance have low moist heat resistance. Pressure sensitive adhesives exhibiting some good properties frequently have a bad balance in total properties.

Even if properties are somewhat ill-balanced, such unbalanced properties will not directly affect characteristics of display devices when the display devices are used in moderate conditions and have a small display area. However, slight unbalance in properties tends to decrease markedly the characteristics of display devices when the devices are used under severe conditions or have a wide screen larger than 100 inches. In detail, unbalanced properties result in the separation or lifting of the pressure sensitive adhesive films by the application of heat or by the use under highly humid and hot conditions.

Accordingly, balanced properties are very important for the pressure sensitive adhesives used in display devices as described above.

Acrylic resin pressure sensitive adhesives are widely used in the above display devices. The acrylic resin pressure sensitive adhesives are basically produced by reacting an alkyl (meth)acrylate, a polar group-containing (meth)acrylate and optionally (meth)acrylic acid, and adding a crosslinking component such as an isocyanate compound to the resultant copolymer to form a crosslinked structure with an appropriate crosslink density. The polar group-containing (meth)acrylate used herein is frequently a hydroxyl group-containing (meth) acrylic compound that is capable of forming an appropriate crosslinked structure with the crosslinking agent isocyanate compound to provide a three dimensional crosslinked structure in the pressure sensitive adhesive itself whereby the slippage on molecular level of the high-molecular acrylic copolymer is prevented. The use, although in a small amount, of the (meth)acrylic acid in the copolymerization enables achieving elongation, break strength and 1000% modulus at high levels.

In the pressure sensitive adhesives used in display devices, the chemical compositions of copolymerization components are almost established and it is considered that balanced properties are provided stably with a fixed variation. It has been hence accepted that the technology of pressure sensitive adhesives in display devices has nearly completed.

It has been accordingly considered that the separation or lifting of functional films will occur at a constant rate under extremely severe conditions and cannot be prevented completely. Further, even though the conditions are severe, they are within temperature conditions such that liquid crystal devices can work. Even if slight separation or lifting occurs under conditions that do not permit the operation of liquid crystals, great importance is not placed on addressing the separation or lifting of pressure sensitive adhesives under such conditions where liquid crystal devices do not work.

However, display devices such as liquid crystal devices are frequently used over long periods of several tens of thousands of hours. It is expected that influences of slightly low properties are accumulated during this long period and eventually reduce the service time of the display devices. If display devices break down because of the lowering in performance of central parts of the display devices such as deterioration of liquid crystal substances or degraded plasma performance, the display devices are considered to have reached the end of their mechanical life. However, the display devices should be free of deteriorated performance due to the separation or lifting of peripheral functional films.

The present inventors have studied pressure sensitive adhesives used in display devices in greater detail from the viewpoints of the above problems. They have then found that some pressure sensitive adhesives are deteriorated more quickly than primary parts such as liquid crystals, requiring improvements.

For example, Patent Document 1 (JP-A-H10-44293) in Comparative Example 3 and Patent Document 2 (JP-A-H10-44294) in Comparative Example 2 disclose examples in which 94.9 parts by weight of butyl acrylate, 5 parts by weight of acrylic acid and 0.1 part by weight of 2-hydroxyethyl acrylate are polymerized into an acrylic polymer having an average molecular weight of 1,550,000 in a solution, and 1.2 parts by weight of trimethylolpropane tolylenediisocyanate is added to the solution to give an acrylic pressure sensitive adhesive, and optical films are produced with the acrylic pressure sensitive adhesive. The above chemical composition provides a 1000% modulus of 16 g/mm² or 30 g/mm², but the elongation is insufficient with a break elongation of 700%. It is also described with respect to optical properties that the polarization degree influencing the visibility is decreased. Accordingly, the pressure sensitive adhesives are evaluated to be inappropriate for use with optical films.

As described above, it is known in the art that n-butyl acrylate, (meth)acrylic acid and a hydroxyl group-containing (meth)acrylate are copolymerized for the production of acrylic polymers. However, the copolymers from these monomers have greatly variable properties such as elongation, break strength and 1000% modulus depending on the amounts of monomers used or polymerization conditions. None of such copolymers has a good balance in these properties.

Adhesives or pressure sensitive adhesives for bonding optical members are described in various documents such as Patent Document 3 (JP-A-S59-111115), Patent Document 4 (JP-A-H03-12471), Patent Document 5 (JP-A-H02-194081), Patent Document 6 (JP-A-2004-91500) and Patent Document 7 (JP-A-2005-196006). However, the adhesives or pressure sensitive adhesives described in these documents have problems in elastic properties and cannot follow the deformation of substrates under severe conditions, often causing separation or lifting.

The display devices such as liquid crystal devices are sometimes used under high temperature and high humidity conditions that are not originally expected, but should be still usable stably under such severe conditions. Of the members constituting the display devices, adhesives or pressure sensitive adhesives are labile to temperature or humidity. It is therefore concerned that functional optical films such as polarizing plates or retardation films bonded through the adhesives or pressure sensitive adhesives are separated due to the alteration by heat of the pressure sensitive adhesives or by the expansion of the pressure sensitive adhesive layer, failing to achieve their performances.

Patent Document 1: JP-A-H10-44293

Patent Document 2: JP-A-H10-44294

Patent Document 3: JP-A-S59-111115

Patent Document 4: JP-A-H03-12471

Patent Document 5: JP-A-H02-194081

Patent Document 6: JP-A-2004-91500

Patent Document 7: JP-A-2005-196006

### SUMMARY OF THE INVENTION

It is an object of the invention to provide novel pressure sensitive adhesives for optical films that are useful in bonding functional optical films used in liquid crystal display devices or the like, and to provide pressure sensitive adhesive optical films having the pressure sensitive adhesive.

It is another object of the invention to provide pressure sensitive adhesives having excellent heat resistance and moist heat resistance.

The present inventors have studied diligently to achieve the above objects and have found that pressure sensitive adhesives for optical films that contain a specific acrylic polymer are very useful for the bonding of functional optical films. The present invention has been completed based on the finding.

A pressure sensitive adhesive for optical films according to the present invention comprises an acrylic copolymer (A) obtained by copolymerizing 95.0 to 98.0 parts by weight of n-butyl acrylate (a), 2.0 to 5.0 parts by weight of a hydroxyl group-containing (meth) acrylate (b) represented by Formula (1) below and not more than 2.0 parts by weight of (meth)acrylic acid (c) (the total of (a) to (c) is 100 parts by weight), the pressure sensitive adhesive satisfying the following requirements (1) to (3):

Requirement (1): the acrylic copolymer (A) has a weight average molecular weight in the range of 1,300,000 to 2,000,000 as measured by gel permeation chromatography relative to polystyrene standards;

Requirement (2): (2-1) the elongation at 90° C. is not less than 1400%, (2-2) the break strength at 90° C. is in the range of 13 to 30 g/mm² and (2-3) the 1000% modulus at 90° C. is in the range of 10 to 20 g/mm², these requirements being measured with respect to samples cut to 5 mm×30 mm×1 mm^{t} from a pressure sensitive adhesive sheet obtained by adding a crosslinking agent (B-1) to the acrylic copolymer (A) dissolved in an organic solvent, applying the solution to a release PET film to form a coating layer such that the dry thickness thereof is 1 mm, removing the solvent by drying, applying a release PET film on the surface of the coating layer, and aging the coating layer at 23° C. and 65% RH for 4 to 7 days;

Requirement (3): the pressure sensitive adhesive sheet has a gel fraction of 65 to 95%;

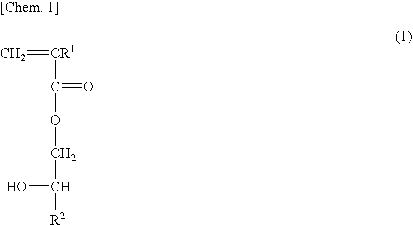

wherein R¹ is a hydrogen atom or a methyl group, and R² is a hydrogen atom or a C1-2 hydrocarbon group.

A pressure sensitive adhesive for optical films according to the present invention may comprises an acrylic copolymer (A) and a crosslinking agent (B-2), the acrylic copolymer (A) being obtained by copolymerizing 95.0 to 98.0 parts by weight of n-butyl acrylate (a), 2.0 to 5.0 parts by weight of a hydroxyl group-containing (meth)acrylate (b) represented by Formula (1) below and not more than 2.0 parts by weight of (meth)acrylic acid (c) (the total of (a) to (c) is 100 parts by weight), the pressure sensitive adhesive satisfying the following requirements (1) to (3):

Requirement (1): the acrylic copolymer (A) has a weight average molecular weight in the range of 1,300,000 to 2,000,000 as measured by gel permeation chromatography relative to polystyrene standards;

Requirement (2): (2-1) the elongation at 90° C. is not less than 1400%, (2-2) the break strength at 90° C. is in the range of 13 to 30 g/mm² and (2-3) the 1000% modulus at 90° C. is in the range of 10 to 20 g/mm², these requirements being measured with respect to samples cut to 5 mm×30 mm×1 mm^{t} from a pressure sensitive adhesive sheet obtained by adding a crosslinking agent (B-1) to the acrylic copolymer (A) dissolved in an organic solvent, applying the solution to a release PET film to form a coating layer such that the dry thickness thereof is 1 mm, removing the solvent by drying, applying a release PET film on the surface of the coating layer, and aging the coating layer at 23° C. and 65% RH for 4 to 7 days;

Requirement (3): the pressure sensitive adhesive sheet has a gel fraction of 65 to 95%;

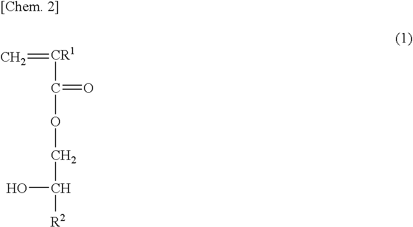

wherein R¹ is a hydrogen atom or a methyl group, and R² is a hydrogen atom or a C1-2 hydrocarbon group.

In Requirement (2), the amount of the crosslinking agent (B-1) is preferably 0.1 to 0.4 part by weight based on 100 parts by weight of the acrylic copolymer (A).

Preferably, the amount of the crosslinking agent (B-2) is 0.1 to 0.4 part by weight based on 100 parts by weight of the acrylic copolymer (A) in the pressure sensitive adhesive for optical films.

The crosslinking agent (B-1) is preferably an isocyanate compound.

The crosslinking agent (B-2) is preferably an isocyanate compound.

The acrylic copolymer (A) is preferably a terpolymer.

Part of the n-butyl acrylate (a) may be replaced by an alkyl (meth)acrylate other than n-butyl acrylate.

In an aspect of the present invention, a pressure sensitive adhesive optical film comprises a functional optical film and a pressure sensitive adhesive layer formed on the functional optical film, the pressure sensitive adhesive layer being formed from a pressure sensitive adhesive for optical films that comprises an acrylic copolymer (A) and a cross linking agent (B-2), the acrylic copolymer being obtained (A) by copolymerizing 95.0 to 98.0 parts by weight of n-butyl acrylate (a), 2.0 to 5.0 parts by weight of a hydroxyl group-containing (meth)acrylate (b) represented by Formula (1) below and not more than 2.0 parts by weight of (meth)acrylic acid (c) (the total of (a) to (c) is 100 parts by weight), the pressure sensitive adhesive satisfying the following requirements (1) to (3):

Requirement (1): the acrylic copolymer (A) has a weight average molecular weight in the range of 1,300,000 to 2,000,000 as measured by gel permeation chromatography relative to polystyrene standards;

Requirement (2): (2-1) the elongation at 90° C. is not less than 1400%, (2-2) the break strength at 90° C. is in the range of 13 to 30 g/mm² and (2-3) the 1000% modulus at 90° C. is in the range of 10 to 20 g/mm², these requirements being measured with respect to samples cut to 5 mm×30 mm×1 mm^{t} from a pressure sensitive adhesive sheet obtained by adding a crosslinking agent (B-1) to the acrylic copolymer (A) dissolved in an organic solvent, applying the solution to a release PET film to form a coating layer such that the dry thickness thereof is 1 mm, removing the solvent by drying, applying a release PET film on the surface of the coating layer, and aging the coating layer at 23° C. and 65% RH for 4 to 7 days;

Requirement (3): the pressure sensitive adhesive sheet has a gel fraction of 65 to 95%;

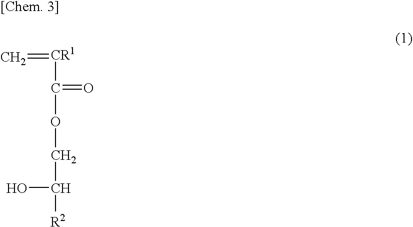

wherein R¹ is a hydrogen atom or a methyl group, and R² is a hydrogen atom or a C1-2 hydrocarbon group.

The acrylic copolymer (A) in the pressure sensitive adhesive for optical films has a main chain mainly comprising structural units derived from n-butyl acrylate. The acrylic copolymer (A) has a side chain represented by Formula (X) below that is derived from the hydroxyl group-containing (meth)acrylate of Formula (1):

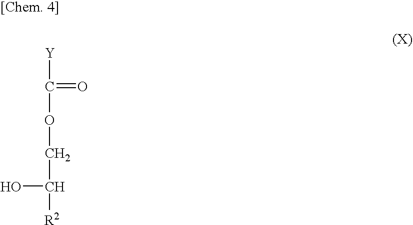

wherein R² is a hydrogen atom or a C1-2 hydrocarbon group, and Y is a bonding to the main chain.

The side chains represented by Formula (X) make it difficult for the main chains of the acrylic copolymer (A) to come close to each other. The structural units derived from the hydroxyl group-containing (meth)acrylate of Formula (1) have the side chains represented by Formula (X) above. The hydroxyl groups in the side chains are reaction sites with the crosslinking agent (an isocyanate compound) to form a crosslinked structure.

In the crosslinking of the acrylic copolymer with the crosslinking agent (an isocyanate compound), the position of the crosslinking sites relative to the main chain greatly affects properties of the obtainable crosslinked acrylic copolymer. In detail, if the crosslinking sites are remote from the main chain of the acrylic copolymer, 1000% elongation can be achieved with a small force. However, the acrylic copolymer reduces the break strength with decreasing elongation, by the increase in number of atoms involved in the crosslinked structure.

The use of the acrylic copolymer (A) enables an elongation of not less than 1400%, a break strength of 13 to 30 g/mm² and a 1000% modulus of 10 to 20 g/mm² that are properties required to attach functional films to display devices.

### ADVANTAGEOUS EFFECTS OF THE INVENTION

The pressure sensitive adhesives for optical films according to the present invention include the acrylic copolymer (A). The acrylic copolymer (A) has the side chains represented by Formula (X), and the hydroxyl groups in the side chains work as reaction sites with the crosslinking agent (an isocyanate compound) to form a crosslinked structure. In detail, the hydroxyl group bonded to the second carbon atom from the —CO—O— group in the side chain of the acrylic copolymer (A) works as a reaction site with the crosslinking agent to form a crosslinked structure. The acrylic copolymer (A) contains a number of side chains having a C4 alkyl group derived from n-butyl acrylate (a).

Hence, when the acrylic copolymer (A) is crosslinked with the crosslinking agent (an isocyanate compound) to form a crosslinked structure, a number of side chains derived from n-butyl acrylate (a) are present around the main chain. The main chains of the acrylic copolymer (A) can come close to each other until a distance corresponding to the length of the side chains, but are very unlikely to come closer to each other. Therefore, the molecules of the acrylic copolymer are not entangled and can slide smoothly to provide high elongation. Further, because the crosslinked structure is formed among the molecules by the reaction with the crosslinking agent (an isocyanate compound) at the hydroxyl groups bonded to the second carbon atom from the —CO—O— group in the side chain of the acrylic copolymer (A), the crosslinked structure inhibits molecular slippage even under tensile stress.

The third component (meth)acrylic acid (c) provides a carboxyl group as a side chain such that the carboxyl group is buried in the surrounding side chains from the n-butyl acrylate (a). Accordingly, the carboxyl groups are less likely to participate in the formation of the crosslinked structure and will be present as they are in the crosslinked acrylic copolymer (A). That is, most of the carboxyl groups contribute to pressure sensitive adhesion of the pressure sensitive adhesives for optical films.

As described hereinabove, the pressure sensitive adhesives for optical films according to the present invention contain the specific acrylic copolymer (A) and thereby exhibit excellent properties.

For example, the use of 4-hydroxy-n-butyl acrylate instead of the hydroxyl group-containing (meth)acrylate (b) of Formula (1) results in too far crosslinking sites from the main chain, so that the properties as described above are not obtained.

### PREFERRED EMBODIMENTS FOR CARRYING OUT THE INVENTION

The pressure sensitive adhesives for optical films of the invention and the pressure sensitive adhesive optical films having the pressure sensitive adhesive will be described in detail hereinbelow.

The pressure sensitive adhesives for optical films according to the present invention contain an acrylic copolymer (A) and preferably a crosslinking agent (B-2). The acrylic copolymer (A) is obtained by copolymerizing 95.0 to 98.0 parts by weight of n-butyl acrylate (a), 2.0 to 5.0 parts by weight of a hydroxyl group-containing (meth)acrylate (b) represented by Formula (1) below and not more than 2.0 parts by weight of (meth)acrylic acid (c) (the total of (a) to (c) is 100 parts by weight). The pressure sensitive adhesives satisfy the following requirements (1) to (3):

Requirement (1): The acrylic copolymer (A) has a weight average molecular weight in the range of 1,300,000 to 2,000,000 as measured by gel permeation chromatography relative to polystyrene standards.

Requirement (2): The elongation at 90° C. is not less than 1400% (2-1), the break strength at 90° C. is in the range of 13 to 30 g/mm² (2-2), and the 1000% modulus at 90° C. is in the range of 10 to 20 g/mm² (2-3). These requirements are measured with respect to samples cut to 5 mm×30 mm×1 mm^{t} from a pressure sensitive adhesive sheet obtained by adding a crosslinking agent (B-1) to the acrylic copolymer (A) dissolved in an organic solvent, applying the solution to a release PET film to form a coating layer such that the dry thickness thereof is 1 mm, removing the solvent by drying, applying a release PET film on the surface of the coating layer, and aging the coating layer at 23° C. and 65% RH for 4 to 7 days.

Requirement (3): The pressure sensitive adhesive sheet has a gel fraction of 65 to 95%.

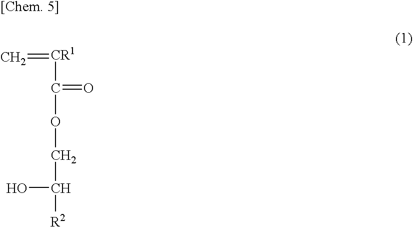

In Formula (1), R¹ is a hydrogen atom or a methyl group, and R² is a hydrogen atom or a C1-2 hydrocarbon group.

The acrylic copolymer (A) used in the pressure sensitive adhesives for optical films includes structural units derived from the n-butyl acrylate (a), structural units derived from the hydroxyl group-containing (meth)acrylate (b) represented by Formula (1), and optionally structural units derived from the (meth)acrylic acid (c).

In the acrylic copolymer (A), part of the n-butyl acrylate (a) may be replaced by other alkyl (meth)acrylate. Examples of the alkyl (meth)acrylates for use with the n-butyl acrylate (a) include (meth)acrylates of C1-18 alkyl groups (other than n-butyl). Preferred examples are methyl (meth)acrylate, ethyl (meth)acrylate, n-propyl (meth)acrylate, iso-propyl (meth)acrylate, iso-butyl (meth)acrylate, tert-butyl (meth)acrylate, iso-octyl (meth)acrylate, pentyl (meth)acrylate, hexyl (meth)acrylate, heptyl (meth)acrylate, octyl (meth)acrylate, nonyl (meth)acrylate, decyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate and 2-ethylhexyl (meth)acrylate.

These additional alkyl (meth)acrylates may be generally used in amounts of 0 to 40 parts by weight, and preferably 0 to 30 parts by weight based on 100 parts by weight of the n-butyl acrylate (a). The alkyl (meth)acrylates other than the n-butyl acrylate may be used in the above amounts without greatly deteriorating the advantageous effects obtained by using the n-butyl acrylate (a) alone. The use of methyl (meth)acrylate and the n-butyl acrylate (a) in combination renders the acrylic copolymer rigid by the amount in which methyl (meth)acrylate is added, and the obtainable copolymer tends to show higher elongation and break strength. In this case, the weight ratio of n-butyl acrylate and methyl (meth)acrylate is generally in the range of 9:1 to 6:4, and preferably 8:2 to 7:3 based on 100 parts by weight of the n-butyl acrylate (a) and methyl (meth)acrylate combined.

In the acrylic copolymers (A) constituting the pressure sensitive adhesives for optical films, the n-butyl acrylate (a) is copolymerized with a hydroxyl group-containing (meth)acrylate (b) represented by Formula (1) below:

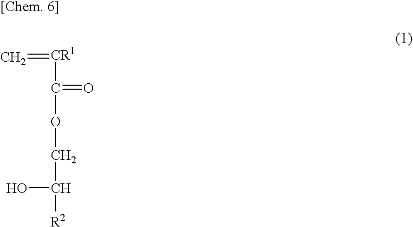

wherein R¹ is a hydrogen atom or a methyl group, and R² is a hydrogen atom or a C1-2 hydrocarbon group.

The compounds of Formula (1) in which R² is a hydrogen atom are 2-hydroxyethyl (meth)acrylates (Formula (I-1) below), those in which R² is a methyl group are 2-hydroxypropyl (meth)acrylates (Formula (2) below), and those in which R² is an ethyl group are 2-hydroxybutyl (meth)acrylates (Formula (3) below).

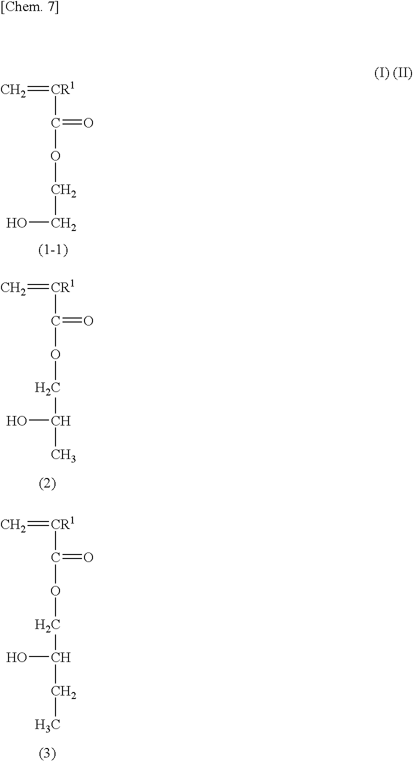

In Formulae (1-1), (2) and (3), R¹ is a hydrogen atom or a methyl group.

As illustrated in Formulae (1-1), (2) and (3) above, the hydroxyl group-containing (meth)acrylates (b) of Formula (1) have a hydroxyl group bonded to the carbon atom (the carbon atom (II) in Formulae (1-1), (2) and (3)) adjacent to the carbon atom (I).

The hydroxyl groups in the hydroxyl group-containing (meth) acrylate react with the crosslinking agent isocyanate compound mainly to form a crosslinked structure among the molecules and regulate the positional relation of the acrylic copolymer molecules. In the acrylic copolymers constituting the pressure sensitive adhesives for optical films, the hydroxyl group bonded to the second carbon atom from the —CO—O— group in the side chain of the acrylic copolymer provides a bonding site to which the crosslinking agent isocyanate compound is bonded. This site is located closer to the main chain than is the end of the side chain derived from n-butyl acrylate in the acrylic copolymer (A) formed of n-butyl acrylate as the main monomer.

As described above, the acrylic copolymer is crosslinked at the crosslinking sites that are the hydroxyl groups having the specific distance from the main chains of the acrylic copolymer (A), whereby the obtainable pressure sensitive adhesives achieve a desired balance of elongation, break strength and 1000% modulus for use as pressure sensitive adhesives to bond optical films.

In contrast to the above hydroxyl group-containing acrylic compounds, compounds represented by Formula (4) below have the hydroxyl group that is bonded to the fourth carbon atom from the —CO—O— group linked to the polymerizable double bond. The use of such acrylic compounds with the hydroxyl group remote from the polymerizable double bond deteriorates the balance of elongation and strength of pressure sensitive adhesives for optical films.

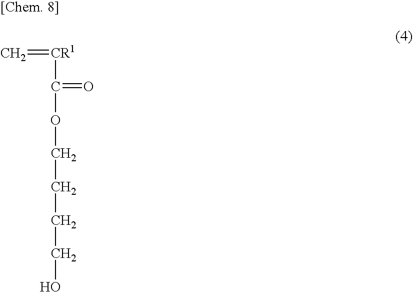

In Formula (4), R¹ is a hydrogen atom or a methyl group.

The acrylic copolymers constituting the pressure sensitive adhesives for optical films may contain (meth) acrylic acid (c) in addition to the n-butyl acrylate (a) and the hydroxyl group-containing (meth)acrylate (b) of Formula (1).

The (meth)acrylic acid is represented by Formula (5) below.

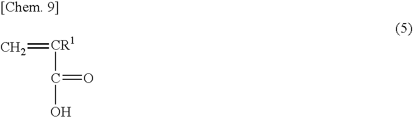

In Formula (5), R¹ is a hydrogen atom or a methyl group.

The acrylic copolymers (A) of the invention are obtained by copolymerizing the n-butyl acrylate (a), the hydroxyl group-containing (meth)acrylate (b) of Formula (1) and optionally the (meth)acrylic acid (c). The acrylic copolymers (A) have at least two kinds of structural units represented by Formulae (7-1) and (7-2) and may have three kinds of structural units represented by Formulae (7-1) to (7-3).

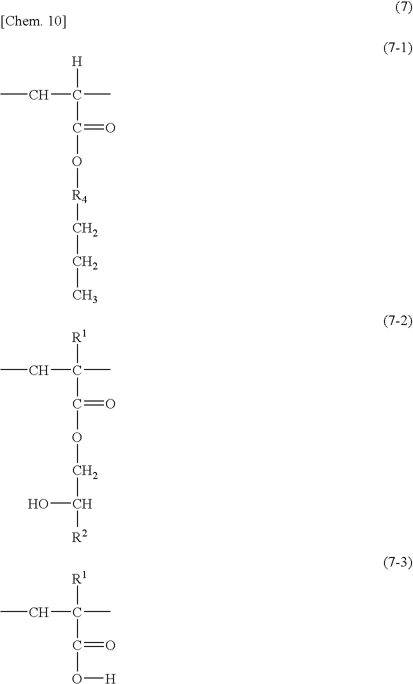

In Formulae (7), R¹ at each occurrence is a hydrogen atom or a methyl group, and R² is a hydrogen atom or a C1-2 hydrocarbon group.

The acrylic copolymers (A) constituting the pressure sensitive adhesives for optical films are obtained by copolymerizing 95.0 to 98.0 parts by weight, preferably 96.0 to 97.5 parts by weight of the n-butyl acrylate (a), 2.0 to 5.0 parts by weight, preferably 2.0 to 4.0 parts by weight of the hydroxyl group-containing acrylic monomer (b) represented by Formula (1), and not more than 2.0 parts by weight, preferably from 0.1 to 1.9 parts by weight of the (meth)acrylic acid (c), based on 100 parts by weight of the total of the n-butyl acrylate (a), the hydroxyl group-containing (meth)acrylate (b) represented by Formula (1) and the (meth)acrylic acid (c).

The acrylic copolymers (A) constituting the pressure sensitive adhesives for optical films are basically terpolymers including the structural units of Formulae (7-1), (7-2) and (7-3). The copolymers may be bipolymers without the structural units of Formula (7-3) or may be quaternary or higher copolymers in which part of the structural units of Formula (7-1) are replaced by structural units derived from the alkyl (meth) acrylates other than the n-butyl acrylate (a).

The acrylic copolymers (A) may further contain structural units from other monomers (such as alkoxyalkyl (meth)acrylates, aryl (meth)acrylate, vinyl acetate, vinylbenzene and styrene) while still achieving the objects of the invention.

These acrylic monomers (A) may be polymerized by various methods such as emulsion polymerization, dispersion polymerization and solution polymerization. In the invention, solution polymerization with an organic solvent as a reaction solvent is preferable.

To produce the acrylic copolymers (A), the monomers for the acrylic copolymer may be dissolved or dispersed in a reaction solvent and a polymerization initiator is added with stirring. Exemplary reaction solvents are organic solvents such as ester solvents such as ethyl acetate; ketone solvents such as methyl ethyl ketone, formaldehyde and acetaldehyde; ether solvents such as dimethyl ether; aromatic solvents such as toluene and xylene; alicyclic solvents such as cyclohexane; and aliphatic solvents such as hexane and octane.

Examples of the polymerization initiators include azo compounds such as 2,2′-azobisisobutyronitrile (AIBN), 2,2′-azobis(4-methoxy-2,4-dimethylvaleronitrile), 2,2′-azobis-2,4-dimethylvaleronitrile and 1,1′-azobiscyclohexane-1-carbonitrile; isobutyryl peroxide, α,α′-bis(neodecanoylperoxy)diisopropylbenzene, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, bis(4-butylcyclohexyl) peroxydicarbonate, benzoyl peroxide, di-tert-butyl peroxide, lauroyl peroxide and tert-butyl-oxy-2-ethyl hexanoate. These initiators may be used singly or in combination.

In the invention, the reaction with the above reaction solvent and the polymerization initiator is generally performed at 50 to 90° C., and preferably 60 to 85° C. The reaction time is generally in the range of 1 to 10 hours, and preferably 2 to 8 hours.

The acrylic copolymers (A) have a weight average molecular weight in the range of 1,300,000 to 2,000,000, and preferably 1,500,000 to 1,850,000 as measured by gel permeation chromatography (GPC) relative to polystyrene standards. This weight average molecular weight of the acrylic copolymers (A) ensures that the obtainable pressure sensitive adhesives will show higher strength.

The acrylic polymers (A) generally have a glass transition temperature of −70° C. to 0° C.

The monomers for the acrylic copolymers (A) are highly reactive and are polymerized substantially at 100% reaction rate. Hence, the proportions of units from these components in the obtainable acrylic copolymer (A) substantially correspond to the amounts of the monomers used.

In the use of the pressure sensitive adhesives for optical films, the acrylic copolymer (A) is preferably reacted with a crosslinking agent (8-2) such that the gel fraction of the acrylic copolymer (A) will be in the range of 65 to 95%, and preferably 70 to 85%, whereby the pressure sensitive adhesives can effectively prevent separation or lifting of optical films. The crosslinking agent (B-2) used herein is generally an isocyanate compound. Examples of the isocyanate compounds include diisocyanate monomers such as tolylene diisocyanate, tetramethylene diisocyanate, diphenylmethane triisocyanate, chlorophenylene diisocyanate, hexamethylene diisocyanate, xylylene diisocyanate, diphenylene methane diisocyanate and hydrogenated diphenylmethane diisocyanate; isocyanate compounds obtained by adding trimethylolpropane or the like to the above isocyanate monomers; isocyanurate compounds; biuret compounds; and urethane prepolymer isocyanates obtained by addition reacting these compounds with polyether polyols, polyester polyols, acrylic polyols, polybutadiene polyols and polyisoprene polyols. These isocyanate compounds may be used singly or in combination. In a preferred embodiment, an addition reaction product of at least one isocyanate compound selected from tolylene diisocyanate, xylylene diisocyanate, hexamethylene diisocyanate and tetramethylene diisocyanate with trimethylolpropane is used for the crosslinking, in which case the elasticity and strength of the obtainable pressure sensitive adhesives can be controlled as required.

To control the gel fraction of the pressure sensitive adhesive with use of the isocyanate compound crosslinking agent (B-2), the crosslinking agent is generally used in an amount of 0.1 to 0.4 part by weight, and preferably 0.15 to 0.30 part by weight based on 100 parts by weight of the acrylic copolymer (A).

The isocyanate compound is bonded with the hydroxyl groups of the hydroxyl group-containing (meth)acrylate (b) of Formula (1) that forms part of the acrylic copolymer (A), resulting in a crosslinked structure. The crosslinking agent (B-2) is mainly bonded with the hydroxyl group bonded to the second carbon atom from the —CO—O— group in the side chain of the acrylic copolymer (A). Such crosslinked structure is moderately rigid and exhibits a favorable elastic force as a pressure sensitive adhesive for optical films as well as high strength. The acrylic copolymers (A) generally contain the (meth)acrylic acid (c), and the carboxyl groups in the (meth)acrylic acid (c) have reactivity with the crosslinking agent. However, because the carboxyl groups derived from the (meth) acrylic acid (c) are present near the main chain of the acrylic copolymer (A) and are sterically hindered by the side chains derived from the n-butyl acrylate (a), they do not substantially react with the crosslinking agent and remain intact as the carboxyl groups.

The acrylic copolymers (A) used in the pressure sensitive adhesives for optical films have the following properties.

The elongation at 90° C. is not less than 1400% (2-1), the break strength at 90° C. is in the range of 13 to 30 g/mm² (2-2), and the 1000% modulus at 90° C. is in the range of 10 to 20 g/mm² (2-3). These properties are measured with respect to samples cut to 5 mm×30 mm×1 mm^{t} from a pressure sensitive adhesive sheet obtained by adding a crosslinking agent (B-1) to the acrylic copolymer (A) dissolved in an organic solvent, applying the solution to a release PET film to form a coating layer such that the dry thickness thereof is 1 mm, removing the solvent by drying, applying a release PET film on the surface of the coating layer, and aging the coating layer at 23° C. and 65% RH for 4 to 7 days. The gel fraction of the pressure sensitive adhesive sheet is in the range of 65 to 95%.

The crosslinking agents (B-1) include those described with respect to the crosslinking agents (B-2), and are generally used in an amount of 0.1 to 0.4 part by weight, and preferably 0.15 to 0.30 part by weight based on 100 parts by weight of the acrylic copolymer (A).

That is, the pressure sensitive adhesives for optical films that contain the acrylic copolymer (A) and the crosslinking agent (B-2) achieve the above properties (2-1) to (2-3) by the crosslinking of the acrylic copolymer (A) with the crosslinking agent (B-2).

The pressure sensitive adhesives for optical films that contain the acrylic copolymer (A) and the crosslinking agent (B-2) do not become hard even after the acrylic copolymer (A) is crosslinked with the crosslinking agent (B-2) and show high elongation at 90° C. of not less than 1400%, and generally from 1400% to 3000%. While the pressure sensitive adhesives have such high elongation, they also have very high break strength ranging from 13 to 30 g/mm², and preferably 13 to 20 g/mm². Further, the 1000% modulus is in the range of 10 to 20 g/mm², and preferably 10 to 15 g/mm². The pressure sensitive adhesives for optical films can thus form a pressure sensitive adhesive layer that can absorb stress generated in a functional film bonded therewith and shows high followability. Hence, the functional film is prevented from separation even when it has deformed.

The pressure sensitive adhesive optical films according to the present invention have a pressure sensitive adhesive layer formed from the foregoing pressure sensitive adhesive on a surface of a functional optical film.

The functional optical films include polarizing films, retardation films and electromagnetic wave shielding films. The pressure sensitive adhesive layer of the pressure sensitive adhesive according to the invention is formed on at least one surface of the functional film.

In the pressure sensitive adhesive optical films, the dry thickness of the pressure sensitive adhesive layer is generally in the range of 10 to 30 and preferably 15 to 25 μm. The pressure sensitive adhesive layer should be provided on at least one surface of the functional film, and may be formed on both surfaces thereof. A plurality of the functional films may be laminated through the pressure sensitive adhesive layer.

The pressure sensitive adhesive for optical films may be directly applied to the surface of the functional film. In a preferred embodiment, an organic solvent that contains the pressure sensitive adhesive containing the acrylic copolymer (A) and the crosslinking agent (B-2) is applied to a release film, the solvent is then removed, and the pressure sensitive adhesive is attached to the surface of the functional film and aged to form a pressure sensitive adhesive layer.

The release film used herein may be a release PET film.

The pressure sensitive adhesives for optical films and the pressure sensitive adhesive optical films according to the present invention have excellent heat resistance and moist heat resistance. Therefore, the functional films bonded to display devices are prevented from separation or lifting even during the long use of the display devices. Even when the devices are used for long periods in high temperature environment or high temperature and high humidity environment, the films will not have separation on lifting. Furthermore, even if the bonding area is large, the film will not separate at near the periphery, or will not separate due to lifting. The acrylic pressure sensitive adhesives according to the invention possess high transparency and do not substantially decrease the light transmittance.

The pressure sensitive adhesives for optical films have adhesion of 5 to 10 N/25 mm and have reworkability.

The pressure sensitive adhesives for optical films are generally used singly after the acrylic copolymer (A) is crosslinked, but may be used together with other pressure sensitive adhesives as long as their properties are not deteriorated.

The pressure sensitive adhesives for optical films may appropriately contain additives such as tackifiers, silane coupling agents, low-molecular acrylic polymers and plasticizers.

The amount of such additives is generally in the range of 0.01 to 100 parts by weight based on 100 parts by weight of the acrylic copolymer (A).

### EXAMPLES

The pressure sensitive adhesives for optical films and the pressure sensitive adhesive optical films of the invention will be described based on examples hereinbelow without limiting the scope of the invention.

### [Evaluation Methods]

### <Measurement of Weight Average Molecular Weight>

The following apparatus was used. The weight average molecular weight was determined relative to polystyrene standards.

Apparatus: HLC-8120 manufactured by TOSOH CORPORATION

Columns: one G7000HXL column, 7.8 mm 1D×30 cm; two GMHXL columns, 7.8 mm 1D×30 cm; one G2500HXL column, 7.8 mm 1D×30 cm

Sample concentration: diluted with 1.5 mg/cm³ with tetrahydrofuran

Eluent: tetrahydrofuran

Flow rate: 1.0 cm³/min

Column temperature: 40° C.

### <Gel Fraction>

Approximately 0.1 g of a crosslinked and aged pressure sensitive adhesive sheet was sampled in a sample bottle, and 30 cc of ethyl acetate was added thereto, followed by shaking for 4 hours. The content in the sample bottle was filtered through a 200 mesh stainless steel screen. The residue on the screen was dried at 100° C. for 2 hours, and the dry weight was measured. The gel fraction was obtained from the following equation.

Gel fraction (%)=(dry weight/sampled pressure sensitive adhesive weight)×100

### <Measurement Methods for 1000% Modulus, Break Strength and Break Elongation>

A pressure sensitive adhesive sheet 1 mm in thickness was cut to 5 mm×30 mm. A stress-strain curve at 90° C. was obtained with a tensile tester (STROGRAPH R3 manufactured by TOXO SEIKI SEISAKU-SHO, LTD.) at a stress rate of 300 mm/min with a distance between chucks of 10 mm, and the 1000% modulus (stress at 1000% strain), the break strength and the break elongation were determined.

### <Heat Resistance>

As will be described in Examples and Comparative Examples, a crosslinking agent was added to an organic solvent solution of an acrylic copolymer to give a coating liquid. The coating liquid was applied to a release treated PET film such that the dry thickness would be 20 μm. A polarizing plate (450 mm×350 mm) was attached thereto, and the adhesive was aged at 23° C. and 65% RH for 7 days.

The optical film was attached to a surface of an alkali-free glass plate 0.7 mm in thickness with use of a laminator and was held in an autoclave at 50° C. and 5 atm for 20 minutes.

The multilayer structure thus produced was exposed to 120° C. for 2000 hours, and the heat resistance of the pressure sensitive adhesive layer was evaluated based on the presence or absence of any separation or lifting of the optical film. The symbols in Tables 2 to 9 indicate the results as follows, and the numbers on the right of the symbols indicate the time until the defect took place.

AA: No defective appearance

CC: Defective appearance

### <Moist Heat Resistance>

A multilayer structure similar to that used in the testing of heat resistance was exposed to 80° C. and 90% RH for 2000 hours, and the heat resistance of the pressure sensitive adhesive layer was evaluated based on the presence or absence of any separation or lifting of the optical film. The symbols in Tables 2 to 9 indicate the results as follows, and the numbers on the right of the symbols indicate the time until the defect took place.

AA: No defective appearance

CC: Defective appearance

### Production Example 1

### Production of Acrylic Copolymer 1

A reactor equipped with a stirrer, a reflux condenser, a thermometer and a nitrogen gas inlet tube was charged with 96.5 parts by weight of n-butyl acrylate (BA), 3 parts by weight of 2-hydroxyethyl acrylate (2HEA), 0.5 part by weight of acrylic acid (AA) and 100 parts by weight of ethyl acetate as a reaction solvent. Further, 0.1 part by weight of 2,2-azobisisobutyronitrile (AIBN) was added. Reaction was performed under a stream of nitrogen gas at 60° C. for 4 hours to give an acrylic copolymer 1.

The acrylic copolymer 1 had a weight average molecular weight of 1,700,000 according to gel permeation chromatography (GPO). The glass transition temperature (Tg) of the acrylic copolymer 1 was −52° C.

### Comparative Production Example 1

### Production of Acrylic Copolymer 1C

An acrylic copolymer 1C was produced in the same manner as in Production Example 1, except that 3 parts by weight of 2-hydroxyethyl acrylate (2HEA) was replaced by 3 parts by weight of 4-hydroxy-n-butyl acrylate (4HBA).

The weight average molecular weight similarly obtained of the acrylic copolymer 1C was 1,730,000. The glass transition temperature (Tg) of the acrylic copolymer 10 was −54° C.

### Production Example 2

### Production of Acrylic Pressure Sensitive Adhesive 2

A reactor equipped with a stirrer, a reflux condenser, a thermometer and a nitrogen gas inlet tube was charged with 95 parts by weight of n-butyl acrylate (BA), 3 parts by weight of 2-hydroxyethyl acrylate (2HEA), 2.0 parts by weight of acrylic acid (AA) and 100 parts by weight of ethyl acetate as a reaction solvent. Further, 0.1 part by weight of 2,2-azobisisobutyronitrile (AIBN) was added. Reaction was performed under a stream of nitrogen gas at 60° C. for 4 hours to give an acrylic copolymer 2.

The acrylic copolymer 2 had a weight average molecular weight of 1,380,000 according to gel permeation chromatography (GPO). The glass transition temperature (Tg) of the acrylic copolymer 2 was −51° C.

### Comparative Production Example 2

### Production of Acrylic Copolymer 2C

An acrylic copolymer 2C was produced in the same manner as in Production Example 2, except that 3 parts by weight of 2-hydroxyethyl acrylate (2HEA) was replaced by 3 parts by weight of 4-hydroxy-n-butyl acrylate (4HBA).

The weight average molecular weight similarly obtained of the acrylic copolymer 2C was 1,440,000. The glass transition temperature (Tg) of the acrylic copolymer 2C was −53° C.

### Production Example 3

### Production of Acrylic Copolymer 3

A reactor equipped with a stirrer, a reflux condenser, a thermometer and a nitrogen gas inlet tube was charged with 97.1 parts by weight of n-butyl acrylate (BA), 2.2 parts by weight of 2-hydroxypropyl acrylate (2HPA), 0.7 part by weight of acrylic acid (AA) and 100 parts by weight of ethyl acetate as a reaction solvent. Further, 0.1 part by weight of 2,2-azobisisobutyronitrile (AIBN) was added. Reaction was performed under a stream of nitrogen gas at 65° C. for 4 hours to give an acrylic copolymer 3.

The acrylic copolymer 3 had a weight average molecular weight of 1,680,000 according to gel permeation chromatography (GPC). The glass transition temperature (Tg) of the acrylic copolymer 3 was −52° C.

### Comparative Production Example 3

### Production of Acrylic Copolymer 3C

An acrylic copolymer 3C was produced in the same manner as in Production Example 3, except that 2.2 parts by weight of 2-hydroxypropyl acrylate (2HPA) was replaced by 2.2 parts by weight of 4-hydroxy-n-butyl acrylate (4HBA).

The weight average molecular weight similarly obtained of the acrylic copolymer 3C was 1,700,000. The glass transition temperature (Tg) of the acrylic copolymer 3C was −54° C.

### Production Example 4

### Production of Acrylic Copolymer 4

A reactor equipped with a stirrer, a reflux condenser, a thermometer and a nitrogen gas inlet tube was charged with 71.5 parts by weight of n-butyl acrylate (BA), 25 parts by weight of methyl acrylate (MA), 3 parts by weight of 2-hydroxypropyl acrylate (2HPA), 0.5 part by weight of acrylic acid (AA) and 100 parts by weight of ethyl acetate as a reaction solvent. Further, 0.1 part by weight of 2,2-azobisisobutyronitrile (AIBN) was added. Reaction was performed under a stream of nitrogen gas at 60° C. for 4 hours to give an acrylic copolymer 4.

The acrylic copolymer 4 had a weight average molecular weight of 1,740,000 according to gel permeation chromatography (GPC). The glass transition temperature (Tg) of the acrylic copolymer 4 was −39° C.

### Comparative Production Example 4

### Production of Acrylic Copolymer 40

An acrylic copolymer 4C was produced in the same manner as an Production Example 4, except that 3 parts by weight of 2-hydroxypropyl acrylate (2HPA) was replaced by 3 parts by weight of 4-hydroxy-n-butyl acrylate (4HBA).

The weight average molecular weight similarly obtained of the acrylic copolymer 4C was 1,790,000. The glass transition temperature (Tg) of the acrylic copolymer 4C was −41° C.

### Production Example 5

### Production of Acrylic Copolymer 5

A reactor equipped with a stirrer, a reflux condenser, a thermometer and a nitrogen gas inlet tube was charged with 96.0 parts by weight of n-butyl acrylate (BA), 4.0 parts by weight of 2-hydroxypropyl acrylate (2HPA) and 100 parts by weight of ethyl acetate as a reaction solvent. Further, 0.1 part by weight of 2,2-azobisisobutyronitrile (AIBN) was added. Reaction was performed under a stream of nitrogen gas at 65° C. for 4 hours to give an acrylic copolymer 5.

The acrylic copolymer 5 had a weight average molecular weight of 1,700,000 according to gel permeation chromatography (GPC). The glass transition temperature (Tg) of the acrylic copolymer 5 was −52° C.

### Comparative Production Example 5

### Production of Acrylic Copolymer 5C

An acrylic copolymer 5C was produced in the same manner as in Production Example 5, except that 4.0 parts by weight of 2-hydroxypropyl acrylate (2HPA) was replaced by 4.0 parts by weight of 3-hydroxypropyl acrylate (3HPA).

The weight average molecular weight similarly obtained of the acrylic copolymer 5C was 1,720,000. The glass transition temperature (Tg) of the acrylic copolymer 5C was −55° C.

### Production Example 6

### Production of Acrylic Copolymer 6

A reactor equipped with a stirrer, a reflux condenser, a thermometer and a nitrogen gas inlet tube was charged with 96.7 parts by weight of n-butyl acrylate (BA), 2.6 parts by weight of 2-hydroxyethyl acrylate (2HEA), 0.7 part by weight of acrylic acid (AA), 2 parts by weight based on 100 parts by weight of (BA) (2HEA) (AA) combined of vinyl acetate (Vac) and 100 parts by weight of ethyl acetate as a reaction solvent. Further, 0.1 part by weight of 2,2-azobisisobutyronitrile (AIBN) was added. Reaction was performed under a stream of nitrogen gas at 60° C. for 4 hours to give an acrylic copolymer 6.

The acrylic copolymer 6 had a weight average molecular weight of 1,600,000 according to gel permeation chromatography (GPC). The glass transition temperature (Tg) of the acrylic copolymer 6 was −54° C.

### Comparative Production Example 6

### Production of Acrylic Copolymer 6C

An acrylic copolymer 6C was produced in the same manner as in Production Example 6, except that 2.6 parts by weight of 2-hydroxyethyl acrylate (2HEA) was replaced by 2.6 parts by weight of 4-hydroxy-n-butyl acrylate (4HBA).

The weight average molecular weight similarly obtained of the acrylic copolymer 6C was 1,620,000. The glass transition temperature (Tg) of the acrylic copolymer 6C was −56° C.

### Production Example 7

### Production of Acrylic Copolymer 7

A reactor equipped with a stirrer, a reflux condenser, a thermometer and a nitrogen gas inlet tube was charged with 95.7 parts by weight of n-butyl acrylate (BA), 2.6 parts by weight of 2-hydroxyethyl acrylate (2HEA), 1.4 parts by weight of 2-hydroxypropyl acrylate (2HPA), 0.3 part by weight of acrylic acid (AA) and 100 parts by weight of ethyl acetate as a reaction solvent. Further, 0.1 part by weight of 2,2-azobisisobutyronitrile (AIBN) was added. Reaction was performed under a stream of nitrogen gas at 60° C. for 4 hours to give an acrylic copolymer 7.

The acrylic copolymer 7 had a weight average molecular weight of 1,810,000 according to gel permeation chromatography (GPC). The glass transition temperature (Tg) of the acrylic copolymer 7 was −52° C.

### Comparative Production Example 7

### Production of Acrylic Copolymer 7C

An acrylic copolymer 7C was produced in the same manner as in Production Example 7, except that 2.6 parts by weight of 2-hydroxyethyl acrylate (2HEA) and 1.4 parts by weight of 2-hydroxypropyl acrylate (2HPA) were replaced by 4 parts by weight of 4-hydroxy-1-n-butyl acrylate (4HBA).

The weight average molecular weight similarly obtained of the acrylic copolymer 7C was 1,880,000. The glass transition temperature (Tg) of the acrylic copolymer 7C was −55° C.

The acrylic copolymers 1 to 7 and the acrylic copolymers 1C to 70 produced above had chemical compositions and properties set forth in Table 1.

### Comparative Production Example 8

### Production of Acrylic Pressure Sensitive Adhesive 80

A reactor equipped with a stirrer, a reflux condenser, a thermometer and a nitrogen gas inlet tube was charged with 92.5 parts by weight of n-butyl acrylate (BA), 7 parts by weight of 2-hydroxyethyl acrylate (2HEA), 0.5 part by weight of acrylic acid (AA) and 100 parts by weight of ethyl acetate as a reaction solvent. Further, 0.1 part by weight of 2,2-azobisisobutyronitrile (AIBN) was added. Reaction was performed under a stream of nitrogen gas at 60° C. for 4 hours to give an acrylic pressure sensitive adhesive 8C.

The acrylic pressure sensitive adhesive 8C had a weight average molecular weight of 1,880,000 according to gel permeation chromatography (GPC). The glass transition temperature (Tg) of the acrylic pressure sensitive adhesive 8C was −51° C.

### Comparative Production Example 9

### Production of Acrylic Pressure Sensitive Adhesive 9C

A reactor equipped with a stirrer, a reflux condenser, a thermometer and a nitrogen gas inlet tube was charged with 98.5 parts by weight of n-butyl acrylate (BA), 1 part by weight of 2-hydroxyethyl acrylate (2HEA), 0.5 part by weight of acrylic acid (AA) and 100 parts by weight of ethyl acetate as a reaction solvent. Further, 0.1 part by weight of 2,2-azobisisobutyronitrile (AIBN) was added. Reaction was performed under a stream of nitrogen gas at 60° C. for 4 hours to give an acrylic pressure sensitive adhesive 9C.

The acrylic pressure sensitive adhesive 9C had a weight average molecular weight of 1,640,000 according to gel permeation chromatography (GPC). The glass transition temperature (Tg) of the acrylic pressure sensitive adhesive 9C was −53° C.

### Comparative Production Example 10

### Production of Acrylic Pressure Sensitive Adhesive 10C

A reactor equipped with a stirrer, a reflux condenser, a thermometer and a nitrogen gas inlet tube was charged with 96.5 parts by weight of n-butyl acrylate (BA), 3 parts by weight of 2-hydroxyethyl acrylate (2HEA), 0.5 part by weight of acrylic acid (AA) and 130 parts by weight of ethyl acetate as a reaction solvent. Further, 0.1 part by weight of 2,2-azobisisobutyronitrile (AIBN) was added. Reaction was performed under a stream of nitrogen gas at 65° C. for 4 hours to give an acrylic pressure sensitive adhesive 10C.

The acrylic pressure sensitive adhesive 10C had a weight average molecular weight of 1,210,000 according to gel permeation chromatography (GPC). The glass transition temperature (Tg) of the acrylic pressure sensitive adhesive 10C was −53° C.

### Comparative Production Example 11

### Production of Acrylic Pressure Sensitive Adhesive 11C

A reactor equipped with a stirrer, a reflux condenser, a thermometer and a nitrogen gas inlet tube was charged with 94 parts by weight of n-butyl acrylate (BA), 6 parts by weight of acrylic acid (AA) and 90 parts by weight of ethyl acetate as a reaction solvent. Further, 0.1 part by weight of 2,2-azobisisobutyronitrile (AIBN) was added. Reaction was performed under a stream of nitrogen gas at 60° C. for 4 hours to give an acrylic pressure sensitive adhesive 11C.

The acrylic pressure sensitive adhesive 11C had a weight average molecular weight of 1,820,000 according to gel permeation chromatography (GPC). The glass transition temperature (Tg) of the acrylic pressure sensitive adhesive 11C was −48° C.

TABLE 1

| Acrylic copolymers | BA | MA | 2HEA | 2HPA | 3HPA | 4HBA | AA | Vac | Mw | Tg (° C.) |
|---|---|---|---|---|---|---|---|---|---|---|
| Acrylic copolymer 1 | 96.5 | | 3 | | | | 0.5 | | 1700000 | −52 |
| Acrylic copolymer 1C | 96.5 | | | | | 3 | 0.5 | | 1730000 | −54 |
| Acrylic copolymer 2 | 95 | | 3 | | | | 2 | | 1380000 | −51 |
| Acrylic copolymer 2C | 95 | | | | | 3 | 2 | | 1440000 | −53 |
| Acrylic copolymer 3 | 97.1 | | | 2.2 | | | 0.7 | | 1680000 | −52 |
| Acrylic copolymer 3C | 97.1 | | | | | 2.2 | 0.7 | | 1700000 | −54 |
| Acrylic copolymer 4 | 71.5 | 25 | | 3 | | | 0.5 | | 1740000 | −39 |
| Acrylic copolymer 4C | 71.5 | 25 | | | | 3 | 0.5 | | 1790000 | −41 |
| Acrylic copolymer 5 | 96 | | | 4 | | | | | 1700000 | −52 |
| Acrylic copolymer 5C | 96 | | | | 4 | | | | 1720000 | −55 |
| Acrylic copolymer 6 | 96.7 | | 2.6 | | | | 0.7 | 2 | 1600000 | −54 |
| Acrylic copolymer 6C | 96.7 | | | | | 2.6 | 0.7 | 2 | 1620000 | −56 |
| Acrylic copolymer 7 | 95.7 | | 2.6 | 1.4 | | | 0.3 | | 1810000 | −52 |
| Acrylic copolymer 7C | 95.7 | | | | | 4 | 0.3 | | 1880000 | −55 |
| Acrylic copolymer 8C | 92.5 | | 7 | | | | 0.5 | | 1880000 | −51 |
| Acrylic copolymer 9C | 98.5 | | 1 | | | | 0.5 | | 1640000 | −53 |
| Acrylic copolymer 10C | 96.5 | | 3 | | | | 0.5 | | 1210000 | −53 |
| Acrylic copolymer 11C | 94 | | | | | | 6 | | 1820000 | −48 |

Notes) In Table 1:
BA: n-butyl acrylate
MA: methyl acrylate
2HEA: 2-hydroxyethyl acrylate
2HPA: 2-hydroxypropyl acrylate
3HPA: 3-hydroxypropyl acrylate
4HBA: 4-hydroxy-n-butyl acrylate
AA: acrylic acid
Vac: vinyl acetate

### Example 1

100 Parts by weight of the acrylic copolymer 1 from Production Example 1 was mixed with 0.2 part by weight of KBE-9007 (an isocyanate silane coupling agent, manufactured by Shin-Etsu Polymer Co., Ltd.) and 0.2 part by weight of an isocyanate crosslinking agent (CORONATE L, manufactured by NIPPON POLYURETHANE INDUSTRY CO., LTD.). The hydroxyl groups in the acrylic copolymer were reacted with the isocyanate crosslinking agent, and a pressure sensitive adhesive for optical films was produced.

The thus-obtained coating liquid was applied to a release treated PET film such that the dry thickness would be 20 μm. The solvent was removed, and the unit was bonded to a polarizing plate. The adhesive was aged at 23° C. and 65% HR for 7 days, and a pressure sensitive adhesive optical film was manufactured.

Separately, the above-obtained coating liquid was applied to a release treated PET film such that the dry thickness would be 1 mm. The solvent was removed, and the unit was bonded to another release treated PET film. The adhesive was aged at 23° C. and 65% HR for 7 days, and a pressure sensitive adhesive sheet was manufactured.

The gel fraction of the pressure sensitive adhesive sheet was 75%.

Properties of the pressure sensitive adhesive, the pressure sensitive adhesive optical film and the pressure sensitive adhesive sheet were measured by the methods described hereinabove. The results are shown in Table 2.

### Comparative Example 1

A pressure sensitive adhesive for optical films, a pressure sensitive adhesive optical film and a pressure sensitive adhesive sheet were manufactured and properties thereof were measured in the same manner as in Example 1, except that the acrylic copolymer 1 from Production Example 1 was replaced by the acrylic copolymer 1C from Comparative Production Example 1 and that the amount of CORONATE L was changed. The results are shown in Table 2.

TABLE 2

| | Ex. 1 | Comp. Ex. 1 |
|---|---|---|
| Acrylic copolymer | Copolymer 1 | Copolymer 1C |
| Amount | 100 parts by weight | 100 parts by weight |
| Crosslinking agent | CORONATE L | CORONATE L |
| Amount | 0.2 part by weight | 0.1 part by weight |
| Gel fraction | 75% | 78% |
| 90° C. elongation | 1500% | 1150% |
| Break strength | 15 g/mm² | 11 g/mm² |
| 1000% modulus | 13 g/mm² | 9 g/mm² |

Heat resistance

| | | |
|---|---|---|
| Separation | AA | CC (100 H) |
| Lifting | AA | AA |

Moist heat resistance

| | | |
|---|---|---|
| Separation | AA | AA |
| Lifting | AA | AA |

### Example 2

100 Parts by weight of the acrylic copolymer 2 from Production Example 2 was mixed with 0.2 part by weight of an isocyanate crosslinking agent (CORONATE L, manufactured by NIPPON POLYURETHANE INDUSTRY CO., LTD.). The hydroxyl groups in the acrylic copolymer were reacted with the isocyanate crosslinking agent, and a pressure sensitive adhesive for optical films was produced.

The thus-obtained coating liquid was applied to a release treated PET film such that the dry thickness would be 20 μm. The solvent was removed, and the unit was bonded to a polarizing plate. The adhesive was aged at 23° C. and 65% HR for 7 days, and a pressure sensitive adhesive optical film was manufactured.

Separately, the above-obtained coating liquid was applied to a release treated PET film such that the dry thickness would be 1 mm. The solvent was removed, and the unit was bonded to another release treated PET film. The adhesive was aged at 23° C. and 65% HR for 7 days, and a pressure sensitive adhesive sheet was manufactured.

The gel fraction of the pressure sensitive adhesive sheet was 82%.

Properties of the pressure sensitive adhesive, the pressure sensitive adhesive optical film and the pressure sensitive adhesive sheet were measured by the methods described hereinabove. The results are shown in Table 3.

### Comparative Example 2

A pressure sensitive adhesive for optical films, a pressure sensitive adhesive optical film and a pressure sensitive adhesive sheet were manufactured and properties thereof were measured in the same manner as in Example 2, except that the acrylic copolymer 2 from Production Example 2 was replaced by the acrylic copolymer 2C from Comparative Production Example 2 and that the amount of CORONATE L was changed. The results are shown in Table 3.

TABLE 3

| | Ex. 2 | Comp. Ex. 2 |
|---|---|---|
| Acrylic copolymer | Copolymer 2 | Copolymer 2C |
| Amount | 100 parts by weight | 100 parts by weight |
| Crosslinking agent | CORONATE L | CORONATE L |
| Amount | 0.2 part by weight | 0.1 part by weight |
| Gel fraction | 82% | 85% |
| 90° C. elongation | 1400% | 980% |
| Break strength | 19 g/mm² | 16 g/mm² |
| 1000% modulus | 16 g/mm² | — |

Heat resistance

| | | |
|---|---|---|
| Separation | AA | CC (500 H) |
| Lifting | AA | CC (1000 H) |

Moist heat resistance

| | | |
|---|---|---|
| Separation | AA | AA |
| Lifting | AA | AA |

### Example 3

100 Parts by weight of the acrylic copolymer 3 from Production Example 3 was mixed with 0.25 part by weight of an isocyanate crosslinking agent (CORONATE L, manufactured by NIPPON POLYURETHANE INDUSTRY CO., LTD.). The hydroxyl groups in the acrylic copolymer were reacted with the isocyanate crosslinking agent, and a pressure sensitive adhesive for optical films was produced.

The thus-obtained coating liquid was applied to a release treated PET film such that the dry thickness would be 20 μm. The solvent was removed, and the unit was bonded to a polarizing plate. The adhesive was aged at 23° C. and 65% HR for 7 days, and a pressure sensitive adhesive optical film was manufactured.

Separately, the above-obtained coating liquid was applied to a release treated PET film such that the dry thickness would be 1 mm. The solvent was removed, and the unit was bonded to another release treated PET film. The adhesive was aged at 23° C. and 65% HR for 7 days, and a pressure sensitive adhesive sheet was manufactured.

The gel fraction of the pressure sensitive adhesive sheet was 81%.

Properties of the pressure sensitive adhesive, the pressure sensitive adhesive optical film and the pressure sensitive adhesive sheet were measured by the methods described hereinabove. The results are shown in Table 4.

### Comparative Example 3

A pressure sensitive adhesive for optical films, a pressure sensitive adhesive optical film and a pressure sensitive adhesive sheet were manufactured and properties thereof were measured in the same manner as in Example 3, except that the acrylic copolymer 3 from Production Example 3 was replaced by the acrylic copolymer 3C from Comparative Production Example 3 and that the amount of CORONATE L was changed. The results are shown in Table 4.

TABLE 4

| | Ex. 3 | Comp. Ex. 3 |
|---|---|---|
| Acrylic copolymer | Copolymer 3 | Copolymer 3C |
| Amount | 100 parts by weight | 100 parts by weight |
| Crosslinking agent | CORONATE L | CORONATE L |
| Amount | 0.25 part by weight | 0.2 part by weight |
| Gel fraction | 81% | 79% |
| 90° C. elongation | 1400% | 1200% |
| Break strength | 14 g/mm² | 12 g/mm² |
| 1000% modulus | 10 g/mm² | 10 g/mm² |

Heat resistance

| | | |
|---|---|---|
| Separation | AA | CC (100 H) |
| Lifting | AA | AA |

Moist heat resistance

| | | |
|---|---|---|
| Separation | AA | AA |
| Lifting | AA | AA |

### Example 4

100 Parts by weight of the acrylic copolymer 4 from Production Example 4 was mixed with 0.2 part by weight of an isocyanate crosslinking agent (CORONATE L, manufactured by NIPPON POLYURETHANE INDUSTRY CO., LTD.). The hydroxyl groups in the acrylic copolymer were reacted with the isocyanate crosslinking agent, and a pressure sensitive adhesive for optical films was produced.

The thus-obtained coating liquid was applied to a release treated PET film such that the dry thickness would be 20 μm. The solvent was removed, and the unit was bonded to a polarizing plate. The adhesive was aged at 23° C. and 65% HR for 7 days, and a pressure sensitive adhesive optical film was manufactured.

Separately, the above-obtained coating liquid was applied to a release treated PET film such that the dry thickness would be 1 mm. The solvent was removed, and the unit was bonded to another release treated PET film. The adhesive was aged at 23° C. and 65% HR for 7 days, and a pressure sensitive adhesive sheet was manufactured.

The gel fraction of the pressure sensitive adhesive sheet was 75%.

Properties of the pressure sensitive adhesive, the pressure sensitive adhesive optical film and the pressure sensitive adhesive sheet were measured by the methods described hereinabove. The results are shown in Table 5.

### Comparative Example 4

A pressure sensitive adhesive for optical films, a pressure sensitive adhesive optical film and a pressure sensitive adhesive sheet were manufactured and properties thereof were measured in the same manner as in Example 4, except that the acrylic copolymer 4 from Production Example 4 was replaced by the acrylic copolymer 4C from Comparative Production Example 4 and that the amount of CORONATE L was changed. The results are shown in Table 5.

TABLE 5

| | Ex. 4 | Comp. Ex. 4 |
|---|---|---|
| Acrylic copolymer | Copolymer 4 | Copolymer 4C |
| Amount | 100 parts by weight | 100 parts by weight |
| Crosslinking agent | CORONATE L | CORONATE L |
| Amount | 0.2 part by weight | 0.1 part by weight |
| Gel fraction | 75% | 79% |
| 90° C. elongation | 2000% | 1000% |
| Break strength | 25 g/mm² | 16 g/mm² |
| 1000% modulus | 17 g/mm² | 16 g/mm² |

Heat resistance

| | | |
|---|---|---|
| Separation | AA | CC (100 H) |
| Lifting | AA | AA |

Moist heat resistance

| | | |
|---|---|---|
| Separation | AA | AA |
| Lifting | AA | AA |

### Example 5

100 Parts by weight of the acrylic copolymer 5 from Production Example 5 was mixed with 0.3 part by weight of an isocyanate crosslinking agent (CORONATE L, manufactured by NIPPON POLYURETHANE INDUSTRY CO., LTD.). The hydroxyl groups in the acrylic copolymer were reacted with the isocyanate crosslinking agent, and a pressure sensitive adhesive for optical films was produced.

The thus-obtained coating liquid was applied to a release treated PET film such that the dry thickness would be 20 p.m. The solvent was removed, and the unit was bonded to a polarizing plate. The adhesive was aged at 23° C. and 65% HR for 7 days, and a pressure sensitive adhesive optical film was manufactured.

Separately, the above-obtained coating liquid was applied to a release treated PET film such that the dry thickness would be 1 mm. The solvent was removed, and the unit was bonded to another release treated PET film. The adhesive was aged at 23° C. and 65% HR for 7 days, and a pressure sensitive adhesive sheet was manufactured.

The gel fraction of the pressure sensitive adhesive sheet was 78%.

Properties of the pressure sensitive adhesive, the pressure sensitive adhesive optical film and the pressure sensitive adhesive sheet were measured by the methods described hereinabove. The results are shown in Table 6.

### Comparative Example 5

A pressure sensitive adhesive for optical films, a pressure sensitive adhesive optical film and a pressure sensitive adhesive sheet were manufactured and properties thereof were measured in the same manner as in Example 5, except that the acrylic copolymer 5 from Production Example 5 was replaced by the acrylic copolymer 5C from Comparative Production Example 5 and that the amount of CORONATE L was changed. The results are shown in Table 6.

TABLE 6

| | Ex. 5 | Comp. Ex. 5 |
|---|---|---|
| Acrylic copolymer | Copolymer 5 | Copolymer 5C |
| Amount | 100 parts by weight | 100 parts by weight |
| Crosslinking agent | CORONATE L | CORONATE L |
| Amount | 0.3 part by weight | 0.15 part by weight |
| Gel fraction | 78% | 83% |
| 90° C. elongation | 1400% | 980% |
| Break strength | 15 g/mm² | 12 g/mm² |
| 1000% modulus | 12 g/mm² | Immeasurable |

Heat resistance

| | | |
|---|---|---|
| Separation | AA | CC (100 H) |
| Lifting | AA | AA |

Moist heat resistance

| | | |
|---|---|---|
| Separation | AA | AA |
| Lifting | AA | AA |

### Example 6

100 Parts by weight of the acrylic copolymer 6 from Production Example 6 was mixed with 0.25 part by weight of an isocyanate crosslinking agent (CORONATE L, manufactured by NIPPON POLYURETHANE INDUSTRY CO., LTD.). The hydroxyl groups in the acrylic copolymer were reacted with the isocyanate crosslinking agent, and a pressure sensitive adhesive for optical films was produced.

The thus-obtained coating liquid was applied to a release treated PET film such that the dry thickness would be 20 p.m. The solvent was removed, and the unit was bonded to a polarizing plate. The adhesive was aged at 23° C. and 65% HR for 7 days, and a pressure sensitive adhesive optical film was manufactured.

Separately, the above-obtained coating liquid was applied to a release treated PET film such that the dry thickness would be 1 mm. The solvent was removed, and the unit was bonded to another release treated PET film. The adhesive was aged at 23° C. and 65% HR for 7 days, and a pressure sensitive adhesive sheet was manufactured.

The gel fraction of the pressure sensitive adhesive sheet was 78%.

Properties of the pressure sensitive adhesive, the pressure sensitive adhesive optical film and the pressure sensitive adhesive sheet were measured by the methods described hereinabove. The results are shown in Table 7.

### Comparative Example 6

A pressure sensitive adhesive for optical films, a pressure sensitive adhesive optical film and a pressure sensitive adhesive sheet were manufactured and properties thereof were measured in the same manner as in Example 6, except that the acrylic copolymer 6 from Production Example 6 was replaced by the acrylic copolymer 6C from Comparative Production Example 6 and that the amount of CORONATE L was changed. The results are shown in Table 7.

TABLE 7

| | Ex. 6 | Comp. Ex. 6 |
|---|---|---|
| Acrylic copolymer | Copolymer 6 | Copolymer 6C |
| Amount | 100 parts by weight | 100 parts by weight |
| Crosslinking agent | CORONATE L | CORONATE L |
| Amount | 0.25 part by weight | 0.15 part by weight |
| Gel fraction | 78% | 76% |
| 90° C. elongation | 1600% | 1200% |
| Break strength | 16 g/mm² | 12 g/mm² |
| 1000% modulus | 13 g/mm² | 10 g/mm² |

Heat resistance

| | | |
|---|---|---|
| Separation | AA | CC (300 H) |
| Lifting | AA | CC (500 H) |

Moist heat resistance

| | | |
|---|---|---|
| Separation | AA | AA |
| Lifting | AA | AA |

### Example 7

100 Parts by weight of the acrylic copolymer 7 from Production Example 7 was mixed with 0.15 part by weight of an isocyanate crosslinking agent (CORONATE L, manufactured by NIPPON POLYURETHANE INDUSTRY CO., LTD.). The hydroxyl groups in the acrylic copolymer were reacted with the isocyanate crosslinking agent, and a pressure sensitive adhesive for optical films was produced.

The thus-obtained coating liquid was applied to a release treated PET film such that the dry thickness would be 20 μm. The solvent was removed, and the unit was bonded to a polarizing plate. The adhesive was aged at 23° C. and 65% HR for 7 days, and a pressure sensitive adhesive optical film was manufactured.

Separately, the above-obtained coating liquid was applied to a release treated PET film such that the dry thickness would be 1 mm. The solvent was removed, and the unit was bonded to another release treated PET film. The adhesive was aged at 23° C. and 65% HR for 7 days, and a pressure sensitive adhesive sheet was manufactured.

The gel fraction of the pressure sensitive adhesive sheet was 78%.

Properties of the pressure sensitive adhesive, the pressure sensitive adhesive optical film and the pressure sensitive adhesive sheet were measured by the methods described hereinabove. The results are shown in Table 8.

### Comparative Example 7

A pressure sensitive adhesive for optical films, a pressure sensitive adhesive optical film and a pressure sensitive adhesive sheet were manufactured and properties thereof were measured in the same manner as in Example 7, except that the acrylic copolymer 7 from Production Example 7 was replaced by the acrylic copolymer 7C from Comparative Production Example 7 and that the amount of CORONATE L was changed. The results are shown in Table 8.

TABLE 8

| | Ex. 7 | Comp. Ex. 7 |
|---|---|---|
| Acrylic copolymer | Copolymer 7 | Copolymer 7C |
| Amount | 100 parts by weight | 100 parts by weight |
| Crosslinking agent | CORONATE L | CORONATE L |
| Amount | 0.15 part by weight | 0.1 part by weight |
| Gel fraction | 78% | 84% |
| 90° C. elongation | 1700% | 1100% |
| Break strength | 17 g/mm² | 12 g/mm² |
| 1000% modulus | 13 g/mm² | 9 g/mm² |

Heat resistance

| | | |
|---|---|---|
| Separation | AA | CC (100 H) |
| Lifting | AA | AA |

Moist heat resistance

| | | |
|---|---|---|
| Separation | AA | AA |
| Lifting | AA | AA |

### Comparative Examples 8 to 11

Acrylic pressure sensitive adhesives for optical films were produced in the same manner as in Example 1, except that the acrylic copolymers 8C to 11C from Comparative Production Examples 8 to 11 were used and that the amount of CORONATE L was changed. Pressure sensitive adhesive optical films were manufactured as described hereinabove using the pressure sensitive adhesives.

The pressure sensitive adhesives, the pressure sensitive adhesive optical films and the pressure sensitive adhesive sheets were tested in the same manner as in Example 1, but good results were not obtained.

The results are shown in Table 9.

TABLE 9

| | Comp. Ex. 8 | Comp. Ex. 9 | Comp. Ex. 10 | Comp. Ex. 11 |
|---|---|---|---|---|
| Acrylic copolymer | Copolymer 8C | Copolymer 9C | Copolymer 10C | Copolymer 11C |
| Amount | 100 parts by | 100 parts by | 100 parts by | 100 parts by |
| | weight | weight | weight | weight |
| Crosslinking agent | CORONATE L | CORONATE L | CORONATE L | CORONATE L |
| Amount | 0.1 part by weight | 0.8 part by weight | 0.35 part by | 1.2 parts by |
| | | | weight | weight |
| Gel fraction | 88% | 70% | 75% | 68% |
| 90° C. elongation | 1100% | 1300% | 1200% | 800% |
| Break strength | 18 g/mm² | 10 g/mm² | 12 g/mm² | 30 g/mm² |
| 1000% modulus | 16 g/mm² | 8 g/mm² | 11 g/mm² | — |

Heat resistance

| | | | | |
|---|---|---|---|---|
| Separation | CC (300 H) | CC (100 H) | CC (100 H) | AA |
| Lifting | AA | CC (100 H) | CC (1500 H) | CC (100 H) |

Moist heat resistance

| | | | | |
|---|---|---|---|---|
| Separation | AA | AA | AA | AA |
| Lifting | AA | CC (150 H) | AA | CC (500 H) |

### INDUSTRIAL APPLICABILITY

In the pressure sensitive adhesives for optical films and the pressure sensitive adhesive optical films of the present invention, the acrylic copolymer (A) has a controlled chemical composition and is crosslinked in a controlled manner, whereby the pressure sensitive adhesive in combination with the crosslinking agent can form an acrylic pressure sensitive adhesive layer having an elongation at 90° C. of not less than 1400%, a break strength at the temperature of not less than 13 g/mm² and a 1000% modulus at the temperature not less than 10 g/mm². While the pressure sensitive adhesives and pressure sensitive adhesive optical films have excellent and balanced elastic properties, they also have excellent optical properties such as total light transmittance and haze.

The pressure sensitive adhesives used for the bonding of optical films show superior heat resistance as well as high moist heat resistance. When they are used to bond films such as polarizing plates or retardation films to liquid crystal display devices or PDP devices, the acrylic pressure sensitive adhesive absorbs internal stress and prevents defects such as separation or lifting.

Even in the event that films are not successfully bonded with the pressure sensitive adhesive sheets or the pressure sensitive adhesives of the invention, the pressure sensitive adhesives can be easily removed from the adherends and be re-applied. In the reworking of the pressure sensitive adhesives, residual adhesives will not be caused on the surface of the adherends.

1. A pressure sensitive adhesive for optical films which comprises an acrylic copolymer (A) obtained by copolymerizing:
95.0 to 98.0 parts by weight of n-butyl acrylate (a),
2.0 to 5.0 parts by weight of a hydroxyl group-containing (meth)acrylate (b) represented by Formula (1) below, and
not more than 2.0 parts by weight of (meth)acrylic acid (c) (the total of (a) to (c) is 100 parts by weight),
the pressure sensitive adhesive satisfying the following requirements (1) to (3):
Requirement (1): the acrylic copolymer (A) has a weight average molecular weight in the range of 1,300,000 to 2,000,000 as measured by gel permeation chromatography relative to polystyrene standards;
Requirement (2): (2-1) the elongation at 90° C. is not less than 1400%, (2-2) the break strength at 90° C. is in the range of 13 to 30 g/mm² and (2-3) the 1000% modulus at 90° C. is in the range of 10 to 20 g/mm², these requirements being measured with respect to samples cut to 5 mm×30 mm×1 mm^{t} from a pressure sensitive adhesive sheet obtained by adding a crosslinking agent (B-1) to the acrylic copolymer (A) dissolved in an organic solvent, applying the solution to a release PET film to form a coating layer such that the dry thickness thereof is 1 mm, removing the solvent by drying, applying a release PET film on the surface of the coating layer, and aging the coating layer at 23° C. and 65% RH for 4 to 7 days;
Requirement (3): the pressure sensitive adhesive sheet has a gel fraction of 65 to 95%; 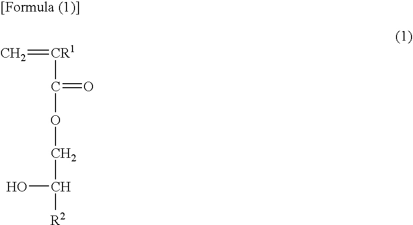
wherein R¹ is a hydrogen atom or a methyl group, and R² is a hydrogen atom or a C1-2 hydrocarbon group.

2. A pressure sensitive adhesive for optical films which comprises an acrylic copolymer (A) and a crosslinking agent (B-2), the acrylic copolymer (A) being obtained by copolymerizing:
95.0 to 98.0 parts by weight of n-butyl acrylate (a),
2.0 to 5.0 parts by weight of a hydroxyl group-containing (meth)acrylate (b) represented by Formula (1) below, and
not more than 2.0 parts by weight of (meth)acrylic acid (c) (the total of (a) to (c) is 100 parts by weight),
the pressure sensitive adhesive satisfying the following requirements (1) to (3):
Requirement (1): the acrylic copolymer (A) has a weight average molecular weight in the range of 1,300,000 to 2,000,000 as measured by gel permeation chromatography relative to polystyrene standards;
Requirement (2): (2-1) the elongation at 90° C. is not less than 1400%, (2-2) the break strength at 90° C. is in the range of 13 to 30 g/mm² and (2-3) the 1000% modulus at 90° C. is in the range of 10 to 20 g/mm², these requirements being measured with respect to samples cut to 5 mm×30 mm×1 mm^{t} from a pressure sensitive adhesive sheet obtained by adding a crosslinking agent (B-1) to the acrylic copolymer (A) dissolved in an organic solvent, applying the solution to a release PET film to form a coating layer such that the dry thickness thereof is 1 mm, removing the solvent by drying, applying a release PET film on the surface of the coating layer, and aging the coating layer at 23° C. and 65% RH for 4 to 7 days;
Requirement (3): the pressure sensitive adhesive sheet has a gel fraction of 65 to 95%; 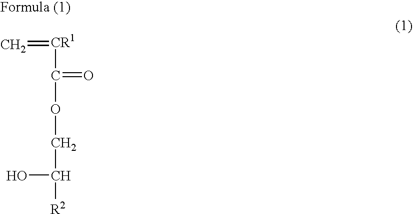
wherein R¹ is a hydrogen atom or a methyl group, and R² is a hydrogen atom or a C1-2 hydrocarbon group.

3. The pressure sensitive adhesive according to claim 1, wherein the amount of the crosslinking agent (B-1) in Requirement (2) is 0.1 to 0.4 part by weight based on 100 parts by weight of the acrylic copolymer (A).

4. The pressure sensitive adhesive according to claim 2, wherein the amount of the crosslinking agent (B-2) is 0.1 to 0.4 part by weight based on 100 parts by weight of the acrylic copolymer (A) in the pressure sensitive adhesive for optical films.

5. The pressure sensitive adhesive according to claim 1, wherein the crosslinking agent (B-1) is an isocyanate compound.

6. The pressure sensitive adhesive according to claim 2, wherein the crosslinking agent (B-2) is an isocyanate compound.

7. The pressure sensitive adhesive according to claim 1, wherein the acrylic copolymer (A) is a terpolymer.

8. The pressure sensitive adhesive according to claim 1, wherein part of the n-butyl acrylate (a) is replaced by an alkyl (meth)acrylate other than n-butyl acrylate.

9. A pressure sensitive adhesive optical film, comprising:
a functional optical film and
a pressure sensitive adhesive layer formed on the functional optical film, the pressure sensitive adhesive layer being formed from a pressure sensitive adhesive for optical films that comprises an acrylic copolymer (A) and a crosslinking agent (B-2), the acrylic copolymer being (A) obtained by copolymerizing:
95.0 to 98.0 parts by weight of n-butyl acrylate (a);
2.0 to 5.0 parts by weight of a hydroxyl group-containing (meth)acrylate (b) represented by Formula (1) below; and
not more than 2.0 parts by weight of (meth)acrylic acid (c) (the total of (a) to (c) is 100 parts by weight);
the pressure sensitive adhesive satisfying the following requirements (1) to (3):
Requirement (1): the acrylic copolymer (A) has a weight average molecular weight in the range of 1,300,000 to 2,000,000 as measured by gel permeation chromatography relative to polystyrene standards;
Requirement (2): (2-1) the elongation at 90° C. is not less than 1400%, (2-2) the break strength at 90° C. is in the range of 13 to 30 g/mm² and (2-3) the 1000% modulus at 90° C. is in the range of 10 to 20 g/mm², these requirements being measured with respect to samples cut to 5 mm×30 mm×1 min^{t} from a pressure sensitive adhesive sheet obtained by adding a crosslinking agent (B-1) to the acrylic copolymer (A) dissolved in an organic solvent, applying the solution to a release PET film to form a coating layer such that the dry thickness thereof is 1 mm, removing the solvent by drying, applying a release PET film on the surface of the coating layer, and aging the coating layer at 23° C. and 65% RH for 4 to 7 days;
Requirement (3): the pressure sensitive adhesive sheet has a gel fraction of 65 to 95%; 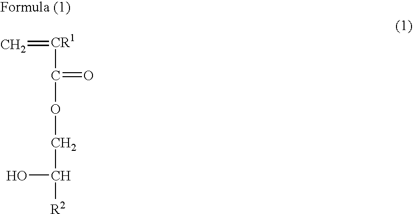
wherein R¹ is a hydrogen atom or a methyl group, and R² is a hydrogen atom or a C1-2 hydrocarbon group.

10. The pressure sensitive adhesive according to claim 2, wherein the amount of the crosslinking agent (B-1) in Requirement (2) is 0.1 to 0.4 part by weight based on 100 parts by weight of the acrylic copolymer (A).

11. The pressure sensitive adhesive according to claim 2, wherein the crosslinking agent (B-1) is an isocyanate compound.

12. The pressure sensitive adhesive according to claim 3, wherein the crosslinking agent (B-1) is an isocyanate compound.

13. The pressure sensitive adhesive according to claim 4, wherein the crosslinking agent (B-1) is an isocyanate compound.

14. The pressure sensitive adhesive according to claim 2, wherein the acrylic copolymer (A) is a terpolymer.

15. The pressure sensitive adhesive according to claim 3, wherein the acrylic copolymer (A) is a terpolymer.

16. The pressure sensitive adhesive according to claim 4, wherein the acrylic copolymer (A) is a terpolymer.

17. The pressure sensitive adhesive according to claim 2, wherein part of the n-butyl acrylate (a) is replaced by an alkyl (meth)acrylate other than n-butyl acrylate.

18. The pressure sensitive adhesive according to claim 3, wherein part of the n-butyl acrylate (a) is replaced by an alkyl (meth)acrylate other than n-butyl acrylate.

19. The pressure sensitive adhesive according to claim 4, wherein part of the n-butyl acrylate (a) is replaced by an alkyl (meth)acrylate other than n-butyl acrylate.

20. The pressure sensitive adhesive according to claim 5, wherein part of the n-butyl acrylate (a) is replaced by an alkyl (meth)acrylate other than n-butyl acrylate.
